(19) United States
(12) Patent Application Publication
(10) Pub. No.: US 2014/0159885 A1
(43) Pub. Date: Jun. 12, 2014

(54) Blind Spot Detection System

(71) Applicant: WISTRON NEWEB CORPORATION, Hsinchu (TW)

(72) Inventors: Tsai-Wang Chang, Hsinchu (TW); Cheng-Hsiung Hsu, Hsinchu (TW); Min-Jung Wu, Hsinchu (TW); Chien-Chung Tseng, Hsinchu (TW)

(73) Assignee: Wistron NeWeb Corporation, Hsinchu (TW)

(21) Appl. No.: 13/798,163

(22) Filed: Mar. 13, 2013

(30) Foreign Application Priority Data
Dec. 10, 2012 (TW) 101146426

(51) Int. Cl. G08G 1/16

(52) U.S. Cl. CPC G08G 1/167
USPC 340/435

(57) ABSTRACT

A blind spot detection system comprises an alarm, capable of generating an alarm signal; a plurality of sensors, each for emitting a radio signal and receiving a reflecting signal of the emitted radio signal, to detect whether an object exists within a specific range and generate a detection result accordingly; and a control module, for receiving at least one vehicle information from the OBD system and controlling the alarm to generate the alarm signal according to the at least one vehicle information and a plurality of detection results generated by the plurality of sensors.

### BACKGROUND OF THE INVENTION

1. Field of the Invention

The present invention relates to a blind spot detection system, and more specifically, to a blind spot detection system capable of simplifying a structure of obtaining vehicle related information, and reducing costs.

2. Description of the Prior Art

According to the statistics, most of traffic accidents are related to drivers' distraction. If a driver is alerted at 0.5 seconds before being likely to have a collision, it can avoid at least 60% of rear-end collisions, 30% of head-on collisions and 50% of road ramp related traffic accidents. If alerted before one second, it can avoid 90% of traffic accidents. The statistics shows traffic accidents can be effectively reduced if the drivers have enough reaction time. Therefore, a blind spot detection (BSD) system, which is a smart vehicle equipment, is developed for such needs.

The BSD system is a safety protection technique for vehicles, and utilizes a radar sensing technique of millimeter wave to achieve early warning. More specifically, the BSD system uses an image self-recognition method of machine vision, to detect obstacles in blind spot areas on left/right/front sides of a vehicle. If the BSD system detects that a specific obstacle exists in a blind spot area, the BSD system actively sends out a message of light or sound, for example, to a driver, so that the driver can determine a driving direction accordingly, to avoid a traffic accident due to the driver's careless or blind side of vision.

Generally speaking, the BSD system deploys sensors in rear and/or front bumpers of a vehicle, emits millimeter wave radio signals, and receives corresponding reflecting signals, to determine whether there is an obstacle, such as another vehicle or a person, within a specific range. Additionally, in order to improve determination accuracy to avoid erroneous determination or alarming, the BSD system requires vehicle related information such as velocity and angle deviation of the vehicle, to determine whether to start BSD or perform debugging; however, the vehicle related information is acquired from an electric control unit of the vehicle through a transmission line or wire. Under such a condition, connection of wires in the vehicle becomes more complex, especially for a modern smart vehicle, which is equipped with more and more functions and accessories (e.g., collision-warning detection radar, lane departure warning radar, reversing radar, anti-lock brake system, electric stable control system, etc.).

On the other hand, configurations of wires in different vehicles are different, such that installing the transmission lines or wires into the vehicle needs the help of the corresponding car factory, which causes increase of installation costs and time consumption. Therefore, how to simplify a structure of obtaining vehicle related information for a BSD system becomes a goal of the industry.

Besides, considering the BSD system can efficiently reduce incidence of traffic accidents, if the manufacturing cost of the BSD system can be further reduced, vehicles equipping with the BSD system can be efficiently increased, such that social costs caused by traffic accidents can be further reduced.

### SUMMARY OF THE INVENTION

It is therefore a primary objective of the present invention to provide a blind spot detection system.

The present invention discloses a blind spot detection system for a vehicle. The blind spot detection system comprises an alarm, capable of generating an alarm signal; a plurality of sensors, each for emitting a radio signal and receiving a reflecting signal of the emitted radio signal, to detect whether an object exists within a specific range and generate a detection result accordingly; and a control module, for receiving at least one vehicle information from the OBD system and controlling the alarm to generate the alarm signal according to the at least one vehicle information and a plurality of detection results generated by the plurality of sensors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a blind spot detection system according to an embodiment of the present invention.

FIG. 2 is a flowchart of a process according to an embodiment of the present invention.

### DETAILED DESCRIPTION

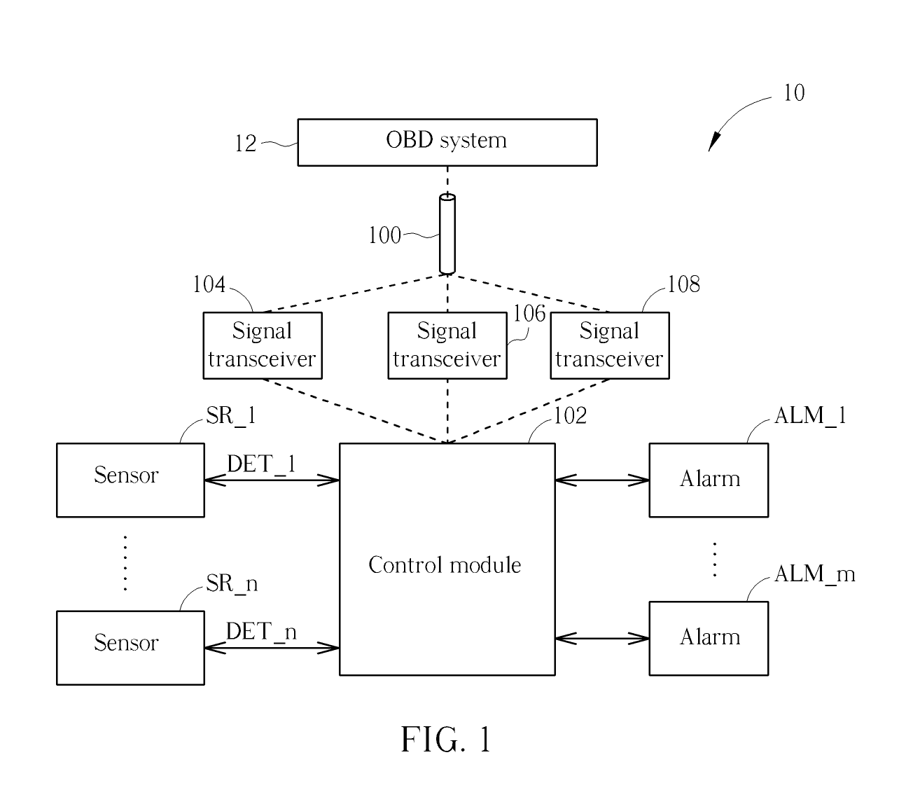

Please refer to FIG. 1, which is a schematic diagram of a blind spot detection (BSD) system 10 according to an embodiment of the present invention. The BSD system 10 is deployed in a vehicle such as a car, a bus or a truck, used for detecting whether there is an obstacle, such as another vehicle or a person, within a specific blind spot area, and emitting an alarm signal accordingly to avoid a traffic accident due to driver's careless or blind side of vision. The vehicle equips with an on-board diagnostics (OBD) system 12, which is utilized for obtaining vehicle information of the vehicle corresponding to an external environment, such as a velocity, an acceleration value, and degree of inclination (corresponding to a plumb line). The BSD system 10 can increase determination accuracy according vehicle information provided from the OBD system 12.

In detail, the BSD system 10 comprises alarms ALM_1-ALM_m, sensors SR_1-SR_n, a transmission line 100, a control module 102 and signal transceivers 104, 106, 108. The sensors SR_1-SR_n are equipped in rear and/or front bumpers of the vehicle, each for detecting whether an object exists in a blind spot area of the driver via the radar sensor technique. That is, the sensors SR_1-SR_n emit radio signals and receive the corresponding reflecting signals, to detect whether objects exist within the specific range, and generate detection results DET_1-DET_n. In addition, a connecting interface between the transmission line 100 and the OBD system 12 preferably conforms to a standard interface of OBD II, but is not limited thereto. The signal transceivers 104, 106, and 108 are connected between the transmission line 100 and the control module 102 for receiving vehicle information from the OBD system 12 through the transmission line 100, converting the vehicle information to a format which is readable by the control module 102, and transmitting the converted vehicle information to the control module 102. More specifically, the signal transceiver 104 is capable of transmitting and receiving signals conforming to a communication standard of international organization for standardization 9143-2 or keyword protocol 2000; the signal transceiver 106 is capable of transmitting and receiving signals conforming to a communication standard of society of automotive engineers J1850, pulse width modulation (PWM), or variable pulse width (VPW); and the signal transceiver 108 is capable of transmitting and receiving signals conforming to a communication standard of international organization for standardization 15756 or control area network. Besides, the signal transceivers 104, 106, and 108 do not need to operate simultaneously but only receive and transmit signals when the corresponding communication protocol is applied. Finally, the control module 102 controls operations of the alarms ALM_1-ALM_m according to the vehicle information and the detection results DET_1-DET_n sent back from the sensors SR_1-SR_n. The alarms ALM_1-ALM_m can be light emitting diodes, horns, etc., for generating alarm signals of light or sounds, so as to remind the driver whether a vehicle or a passenger approaches. The number m of the alarms ALM_1-ALM_m is not ruled, as long as greater than 1.

In short, in the BSD system 10, the vehicle information needed by the control module 102 when the control module 102 performs BSD is provided by the OBD system 12 originally installed in the vehicle. In other words, the control module 102 does not acquire the vehicle information such as velocity and angle deviation from an electric control unit inside the vehicle, thereby decreasing the deployment of wires inside the vehicle, and avoiding the vehicle information being interfered during transmission.

Please note that, the BSD system 10 shown in FIG. 1 is an embodiment of the present invention, and those skilled in the art can make modifications accordingly, which is not limited thereto. For example, according to different OBD systems in the vehicle, the connecting interface between the transmission line 100 and the OBD system 12 can be any of standard interfaces of OBD system such as OBD I, OBD-1.5, EOBD, EOBD II, etc., and is not limited to OBD II. As long as the BSD system 10 comprises signal transceivers corresponding to the standard interfaces, the signal transceivers are capable of converting signals to formats which are readable by the control module 102. Besides, the communication protocols corresponding to the signal transceivers 104, 106, and 108 are examples for description, and those skilled in the art can choose different transceivers according to different communication protocols, which is not limited thereto. On the other hand, according to the communication protocol followed by the signal transceiver 104 and specification of the standard interface of OBD II, the signal transceiver 104 must connect to the seventh and fifteenth pins of the transmission line 100. In the same way, the transceivers 106 and 108 must connect to the second, tenth, and sixth, fourteenth pins of the transmission line 100 respectively for receiving signals conforming to the communication protocols corresponding to the signal transceivers 106 and 108. As can be seen, a connection between the transceivers and the transmission line 100 must be modified according to different communication protocols corresponding to the transceivers. Those skilled in the art can make modifications accordingly, which is not limited thereto.

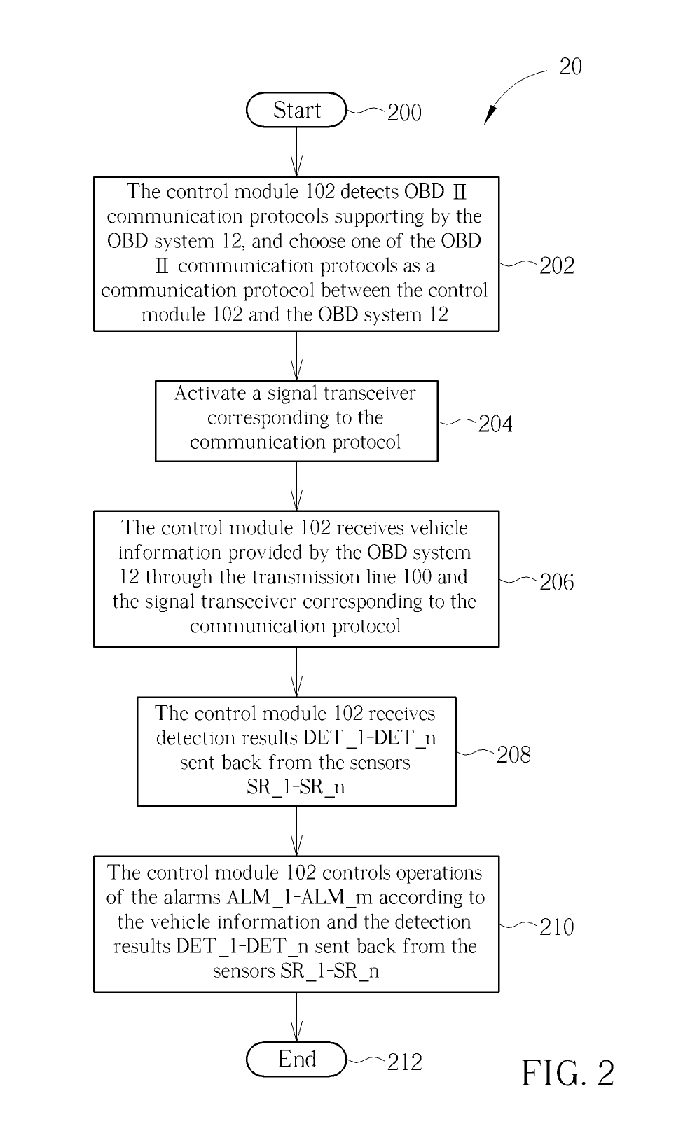

The operation of the BSD system 10 can be summarized to a process 20 as shown in FIG. 2. The process 20 includes the following steps:

Step 200: Start.

Step 202: The control module 102 detects OBD II communication protocols supporting by the OBD system 12, and choose one of the OBD II communication protocols as a communication protocol between the control module 102 and the OBD system 12.

Step 204: Activate a signal transceiver corresponding to the communication protocol.

Step 206: The control module 102 receives vehicle information provided by the OBD system 12 through the transmission line 100 and the signal transceiver corresponding to the communication protocol.

Step 208: The control module 102 receives detection results DET_1-DET_n sent back from the sensors SR_1-SR_n.

Step 210: The control module 102 controls operations of the alarms ALM_1-ALM_m according to the vehicle information and the detection results DET_1-DET_n sent back from the sensors SR_1-SR_n.

Step 212: End.

As mentioned in the above, the conventional BSD system obtains vehicle related information such as velocity and angle deviation from the electric control unit inside the vehicle, which increases the difficulty of deployment and decreases the convenience. In comparison, in the BSD system 10 of the present invention, the vehicle information required by the control module 102 for performing BSD is provided by the OBD system 12 which is built in the vehicle, thereby decreasing the deployment of wires inside the vehicle, simplifying entire structure, reducing costs, and avoiding the vehicle information being interfered during transmission.

In sum, the BSD system of the present invention is capable of simplifying a structure of obtaining vehicle related information, and reducing costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A blind spot detection system for a vehicle comprising an On-Board Diagnostics (OBD) system, the blind spot detection system comprising:
an alarm, capable of generating an alarm signal;
a plurality of sensors, each for emitting a radio signal and receiving a reflecting signal of the emitted radio signal, to detect whether an object exists within a specific range and generate a detection result accordingly; and
a control module, for receiving at least one vehicle information from the OBD system and controlling the alarm to generate the alarm signal according to the at least one vehicle information and a plurality of detection results generated by the plurality of sensors.

2. The blind spot detection system of claim 1, further comprising a transmission line, connecting the OBD system and the control module, for transmitting the at least one vehicle information.

3. The blind spot detection system of claim 2, wherein a connecting interface of the transmission line conforms to a standard interface of OBD II.

4. The blind spot detection system of claim 2, further comprising a plurality of signal transceivers, disposed between the transmission line and the control module, for converting data between the transmission line and the control module.

5. The blind spot detection system of claim 4, wherein one of the plurality of signal transceivers is capable of transmitting and receiving signals conforming to a communication standard of international organization for standardization 9143-2 or keyword protocol 2000.

6. The blind spot detection system of claim 4, wherein one of the plurality of signal transceivers is capable of transmitting and receiving signals conforming to a communication standard of society of automotive engineers J1850, pulse width modulation (PWM), or variable pulse width(VPW).

7. The blind spot detection system of claim 4, wherein one of the plurality of signal transceivers is capable of transmitting and receiving signals conforming to a communication standard of international organization for standardization 15756 or control area network.
